(19) United States
(12) Patent Application Publication
(10) Pub. No.: US 2006/0085404 A1
(43) Pub. Date: Apr. 20, 2006

(54) Method, apparatus, and computer program product updating software in an information processing apparatus

(75) Inventor: Seiji Kusunoki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/044,309

(22) Filed: Jan. 27, 2005

(30) Foreign Application Priority Data
Oct. 20, 2004 (JP) 2004-306089

(51) Int. Cl. G06F 17/30

(52) U.S. Cl. 707/3

(57) ABSTRACT

A software that needs updating has been installed in a plurality of information processing apparatuses that are connected to each other via a network. A correction file and a test program are distributed to the information processing apparatuses. The correction file contains data required for updating the software and the test program is for performing operation validation of the software after installation of the correction file. Once the information processing apparatuses have installed the correction file, the information processing apparatuses are instructed to execute the test program. The results of execution of the test program are collected from the information processing apparatuses and the results are notified to an operator.

### BACKGROUND OF THE INVENTION

1) Field of the Invention

The present invention relates to a technology that makes it possible to automatically update a software in a plurality of information processing apparatuses.

2) Description of the Related Art

It is usual to supply the correction files of a software to the users on media such as CD-ROMs. However, there is a limitation on the number of correction files that can be stored on a medium; moreover, the user is often required to know how to handle the correction files. For example, if there are many computers in the office that are installed with the software that needs updating, a system manager or the like must go to each of the computer and install the correction files in those computers. This puts a lot of burden on the system manager.

One approach is to connect the computers to a network and distribute the correction files via the network. In this approach, the correction files are installed in a distribution server to which the computers can access to automatically install the correction files. As a result, the burden on the system manager is reduced. A related art has been disclosed in Japanese Application Laid-Open No. H07-225724.

However, even in the above approach of using a network to install the correction files the system manager must check if there are any correction files for updating the software, and get the correction files and load them on the distribution server. In other words, there is still some burden on the system manager.

In an office or the like, a software required for reliability often requires an operation validation after application of the correction file. This is because a software applied with the correction file may not operate normally due to a fault of the correction file itself or any abnormality occurred during application processing. The operation confirmation work is also left in the system manager as burden imposed on him/her.

### SUMMARY OF THE INVENTION

It is an object of the present invention to solve at least the problems in the conventional technology.

An apparatus according to an aspect of the present invention updates a software that has been installed in a plurality of information processing apparatuses that are connected to each other via a network. The apparatus includes a distributing unit that distributes to the information processing apparatuses both a correction file that contains data required for updating the software and a test program that performs operation validation of the software after installation of the correction file; an instructing unit that instructs execution of the test program to the information processing apparatuses after the information processing apparatuses have received the correction file and the test program and have installed the correction file; a result acquiring unit that acquires a result of execution of the test program from the information processing apparatuses that have executed the test program; and a notifying unit that notifies the result.

A method according to an aspect of the present invention is a method of updating a software that has been installed in a plurality of information processing apparatuses that are connected to each other via a network. The method includes distributing to the information processing apparatuses both a correction file that contains data required for updating the software and a test program that performs operation validation of the software after installation of the correction file; instructing execution of the test program to the information processing apparatuses after the information processing apparatuses have received the correction file and the test program and have installed the correction file; acquiring a result of execution of the test program from the information processing apparatuses that have executed the test program; and notifying the result.

A computer program product according to still another aspect of the present invention implements the above method on a computer.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is an explanatory diagram for explaining a preparation procedure performed before application of a software updating system according to an embodiment;

FIG. 2 is an explanatory diagram for explaining an outline of an implementation procedure of the software updating system according to an embodiment;

FIG. 3 is a functional block diagram showing a configuration of the software updating apparatus according to the embodiment;

FIG. 4 is a sample table showing one example of a configuration information DB;

FIG. 5 is a sample diagram showing one example of a software updating execution result screen;

FIG. 6 is a flowchart showing a processing procedure of the software updating apparatus shown in FIG. 3; and

FIG. 7 is a functional block diagram showing a computer executing a software updating program.

### DETAILED DESCRIPTION

Exemplary embodiments of the present invention will be explained below in detail with reference to the drawings.

A case is explained below in which a software in a server is updated; however, the present invention is not limited to updating of software is a server. Precisely, the present invention can be applied to updating of a software in any information processing apparatus such a personal computer.

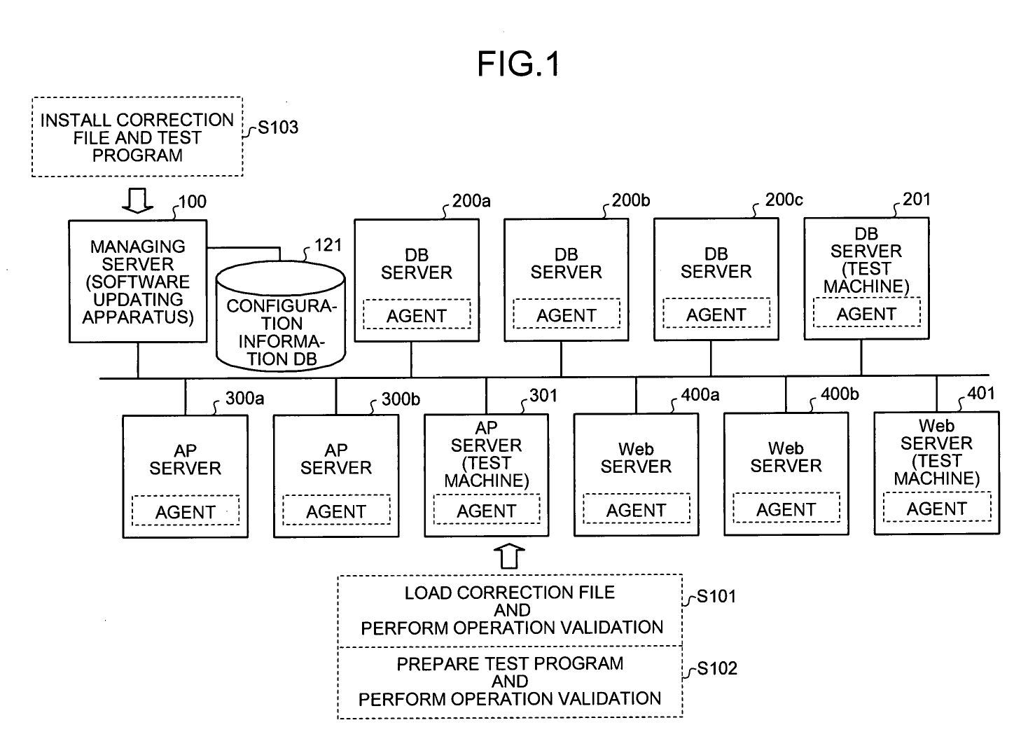

First of all, an outline of a software updating system according to the embodiment will be explained. FIG. 1 is an explanatory diagram for explaining a preparation procedure performed before application of a software updating system according to the first embodiment. This software updating system includes a managing server 100 that accumulates information relating to configuration (hereinafter, “configuration information”) of a plurality of servers and stores the configuration information. The managing server 100 functions as a software updating apparatus.

The managing server 100 is a server that communicates with agents installed in various servers connected to a network in advance to perform collection of configuration information pieces of a hardware and a software or issue various work instructions.

Database (DB) servers 200a to 200c are servers for providing a database function. All the database (DB) servers 200a to 200c have the same hardware configuration and software configuration. The DB server 201 is a DB server for test. The DB server 201 has the same hardware configuration and software configuration as those of the DB servers 200a to 200c. When a certain scale of system is operated, it is common to prepare such a server for test for the purpose of validating a new function or fault repair or the like in addition to servers that perform actual operation.

AP servers 300a to 300b are servers that provide business logic. The AP servers 300a to 300b have the same hardware configuration and the same software configuration. AP server 301 is an AP server for test. The AP server 301 has the same hardware configuration and software configuration as those of the AP servers 300a to 300b.

Web servers 400a to 400b are servers that provide HTTP (HyperText Transfer Protocol). The Web servers 400a to 400b have the same hardware configuration and the same software configuration. Web server 401 is a Web server for test. The Web server 401 has the same hardware configuration and software configuration as those of the Web servers 400a to 400b.

It is assumed here that a software in the AP servers 300a to 300b requires updating. A system manager in usual manner loads a correction file to the AP server 301, which is the test machine, and performs operation validation to checks whether the software runs properly on the AP server 301 (Step S101).

If the software runs properly on the AP server 301, a test program is prepared and operation validation is performed to check whether the test program runs properly (Step S102). The test program is a program that is executed after an application of a correction file to the AP servers 300a to 300b to validate that there is no problem in application of the correction file. The content of the test program can vary depending on the configuration of a server or the operating system.

Subsequently, the correction file and the prepared test program are installed in a predetermined place in the managing server 100 (Step S103). This completes the preparation work.

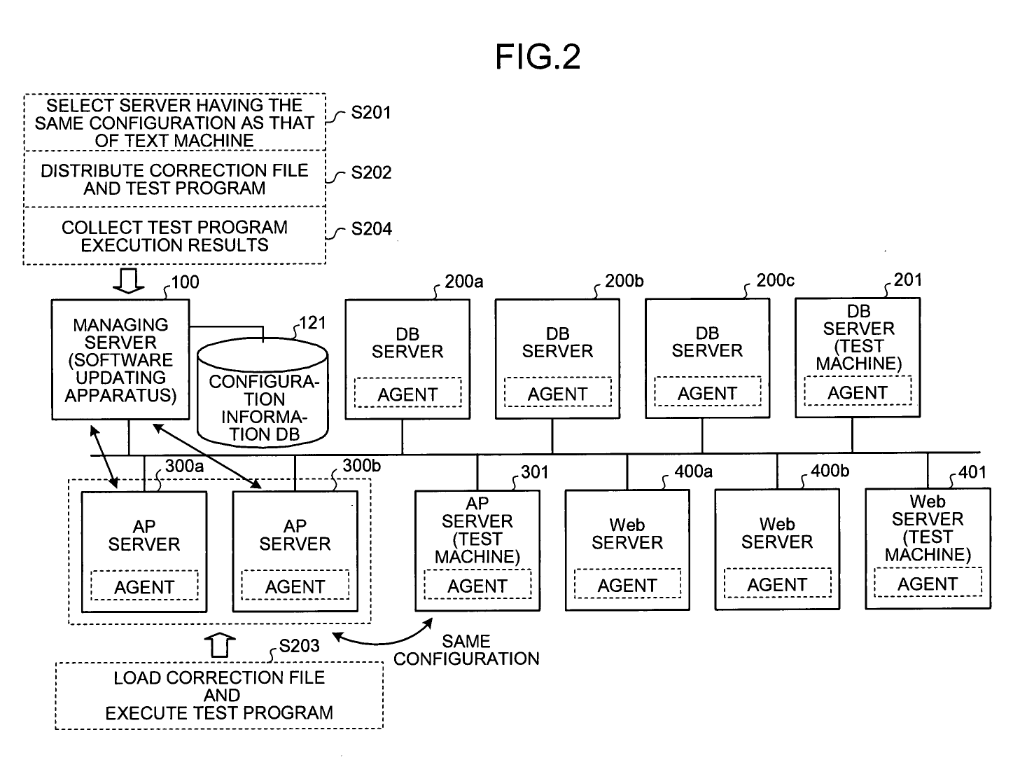

FIG. 2 is an explanatory diagram for explaining an outline of an implementation procedure of a software updating system according to this embodiment. The system manager instructs the software updating apparatus 100 which is a managing server to perform software updating to a server(s) having the same configuration as the AP server 301.

The software updating apparatus 100 that receives the instruction refer to the configuration information DB 121 storing the configuration information for a server to select a server(s) having the same configuration as that of the AP server 310 (Step S201). Specifically, in this embodiment, the AP server 300a and the AP server 300b are selected as servers having the same configuration as that of the AP server 301.

Subsequently, the software updating apparatus 100 distributes the correction file and the test program to the selected servers (Step S202). The software updating apparatus 100 instructs the servers distributed with the correction file and the test program to perform application of the correction file and executing the test program (Step S203). Upon completion, the software updating apparatus 100 collects the execution results of the test program to notify the same to the system manager (Step S204).

In the software updating system according to the embodiment, thus, since such a constitution is employed that steps of selecting a server(s) having the same configuration as that of a test machine that has performed an operation validation of a correction file to transmitting and applying the correction file to the servers are automatically performed, even if a plurality of information processing apparatuses that are applied with the correction file are present, burden imposed on the system manager is not increased.

In the software updating system according to the embodiment, a constitution is employed so as to distribute the test program together with the correction file, execute the test program after application of the correction file, and collect the execution results to notify them to the system manager, burden imposed on the system manager who is required for performing the operation validation work is also reduced.

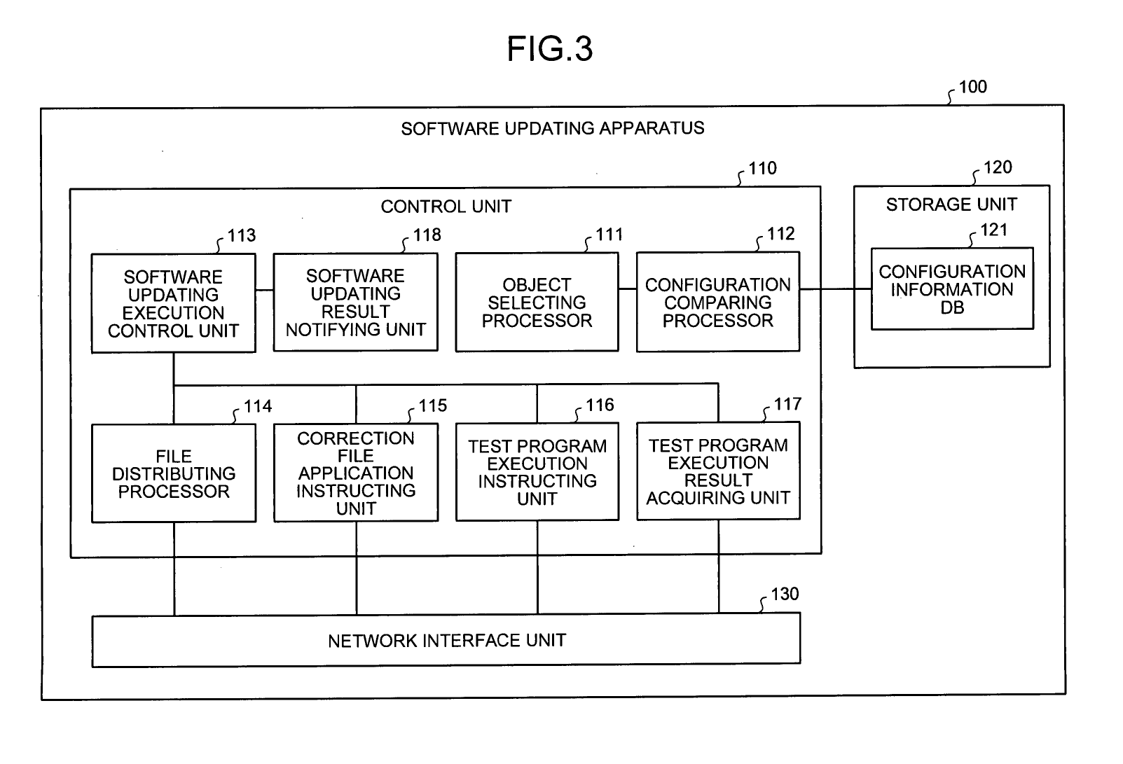

Next, a configuration of the software updating apparatus according to the embodiment will be explained. FIG. 3 is a functional block diagram showing a configuration of the software updating apparatus according to the embodiment. As shown in FIG. 3, the software updating apparatus 100 has a control unit 110, a storage unit 120, and a network interface unit 130.

The control unit 110 is a control unit that controls the whole software updating apparatus, and has an object selecting processor 111, a configuration comparing processor 112, a software updating execution control unit 113, a file distributing processor 114, a correction file application instructing unit 115, a test program execution instructing unit 116, a test program execution result acquiring unit 117, and a software updating result notifying unit 118.

The object selecting processor 111 is a processor that selects an information processing apparatus(es) having the same configuration as the designated processing apparatus. Specifically, the object selecting processor 111 sequentially performs a processing which acquires configuration information pieces about all the information processing apparatuses that are management objects from the configuration information DB 121 and a processing which delivers a configuration information piece about the designated information processing apparatus and a configuration information piece about another information processing apparatus to the configuration comparing processor 112 and causes the configuration comparing processor 112 to determine whether configurations of both the information processing apparatuses are identical to each other.

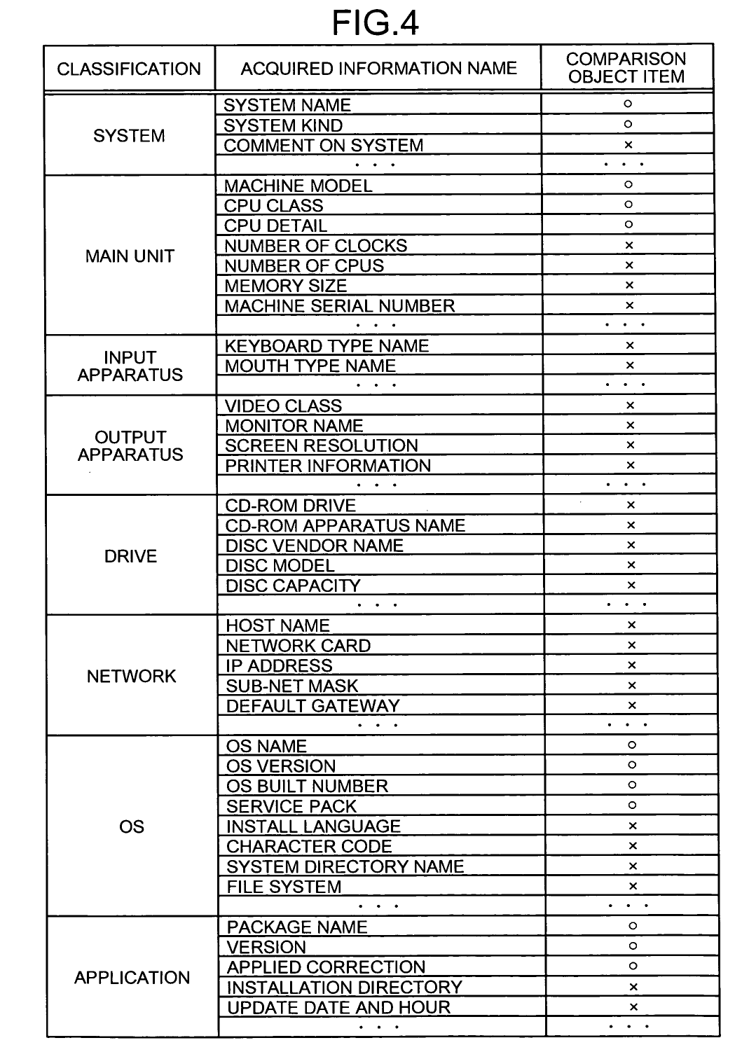

The configuration comparing processor 112 is a processor that compares configuration information pieces, about two information processing apparatuses with each other on a predetermined determining logic to determine whether the two information processing apparatuses have the identical configuration. Here, one example of the determining logic for identification is shown. FIG. 4 is a sample table showing one example of the constitution information DB 121.

As shown in FIG. 4, information pieces about a plurality of items are stored in the configuration information DB 121 for each classification such as main unit, OS, or application. Each item is determined in advance about whether it is a comparison object item for identification determination. For example, regarding the classification “system”, the item “system name” and the item “system kind” are the comparison object items, but the item “comment on system” is not the comparison object item. The configuration comparing processor 112 determines that two information processing apparatuses have the identical configuration, when all the comparison object items between the two information processing apparatuses are coincident with each other.

The software updating execution control unit 113 is a control unit that controls processing steps of distributing a file required for software updating to notifying the execution result of the test program. The file distributing processor 114 is a processor that distributes the correction file and the test program to the designated information processing apparatus(es). The correction file application instructing unit 115 is a processor that instructs an agent installed in advance in the information processing apparatus that is a software update object to apply the correction file that the file distributing processor 114 has distributed.

The test program execution instructing unit 116 is a processor that instructs the agent installed in advance in the information processing apparatus that is a software up date object to execute the test program that the file distributing processor 114 has distributed. The test program execution result acquiring unit 117 is a processor that acquires the execution results from the information processing apparatus that has executed the test program.

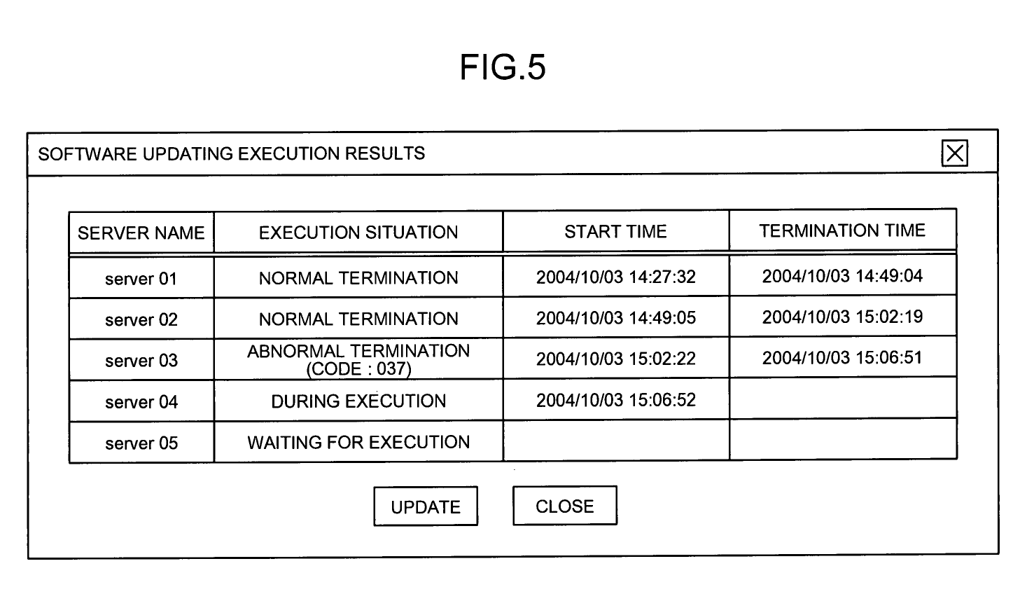

The software update result notifying unit 118 is a processor that notifies the execution result to an operator who has performed the processing by displaying the execution result of the test program that the test program execution result acquiring unit 117 has acquired on a software updating execution result screen. FIG. 5 is a sample diagram showing one example of the software updating execution result screen.

As shown in FIG. 5, a table constituted of four items of server name, execution situation, start time, and termination time is displayed on the software updating execution result screen. Names of information processing apparatuses selected by the object selecting processor 111 are listed in a column for the server name. Execution situations of software updating processings for respective information processing apparatuses are displayed in a column for the execution situation. For example, the execution situation for the server 1 in the first line is displayed as “normal termination”, which indicates such a fact that it has been validated by execution of the test program that there is no problem. The execution situation for the server 3 in the third line is displayed as “abnormal termination (code: 037)”, which indicates such a fact that abnormality indicated by the code “037” has been found during execution of the test program.

The storage unit 120 is a storage unit that stores various information pieces, and has the configuration information DB 121. The configuration of the configuration information DB 121 has been explained in FIG. 4, and explanation thereof will be omitted here. The network interface unit 130 is an interface that performs reception/transmission of information pieces or data pieces from/to other information processing apparatuses through a network(s).

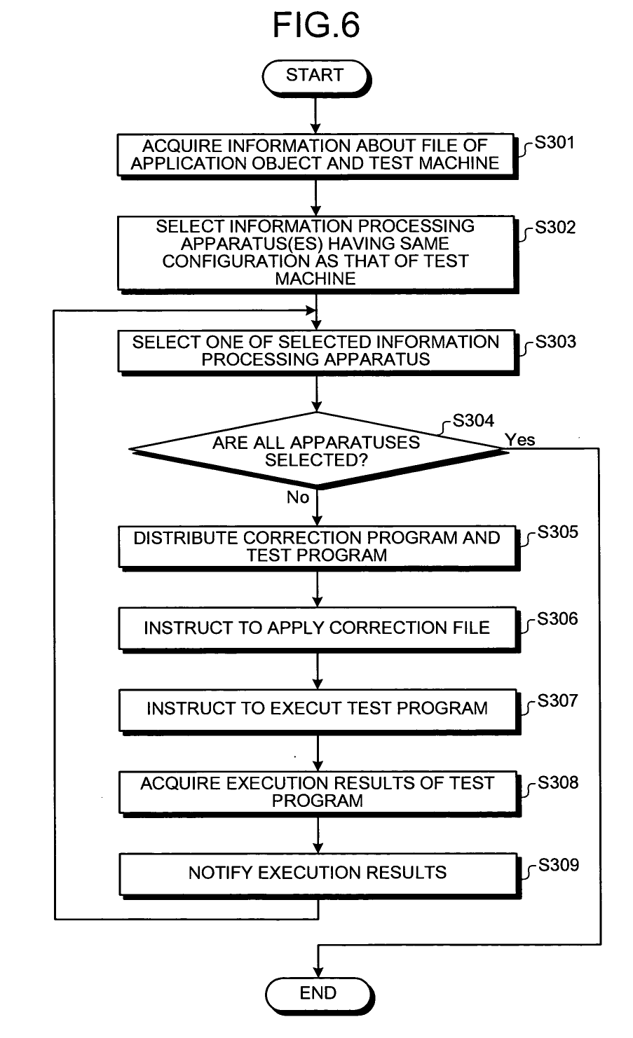

Next, a processing procedure of the software updating apparatus 100 will be explained. FIG. 6 is a flowchart showing a processing procedure of the software updating apparatus 100 shown in FIG. 3. As shown in FIG. 6, when the software updating apparatus 100 acquires information about the correction file and test program used in the software updating processing and information about the test machine performing the operation validation of the correction file and the test program (Step S301), it refers to the configuration information DB 121 to select an information processing apparatus(es) having the same configuration as the test machine (Step S302).

The software updating apparatus 100 selects one information processing apparatus whose software updating has not been performed yet from the selected information processing apparatuses (Step S303). Here, when the software updating apparatus 100 has selected all the selected information processing apparatuses (Step S304, Yes), it terminates the processing. When the software updating apparatus 100 selects an information processing apparatus whose software updating has not been performed yet (Step S304, No.), it distributes the correction file and the test program acquired in step S301 to the information processing apparatus (Step S305).

When the software updating apparatus 100 has completed the distribution, it instructs the information processing apparatus distributed with the correction file and the test program to apply the correction file thereto (Step S306). Subsequently, the software updating apparatus 100 instructs the information processing apparatus distributed with the correction file and the test program to execute the test program (Step S307) and acquires the execution result after the execution has been completed (Step S308). The software updating apparatus 100 completes a series of processings by notifying the acquired execution results to the operator through screen display thereof (Step S309), and it moves to step S303 to perform software updating to the next information processing apparatus.

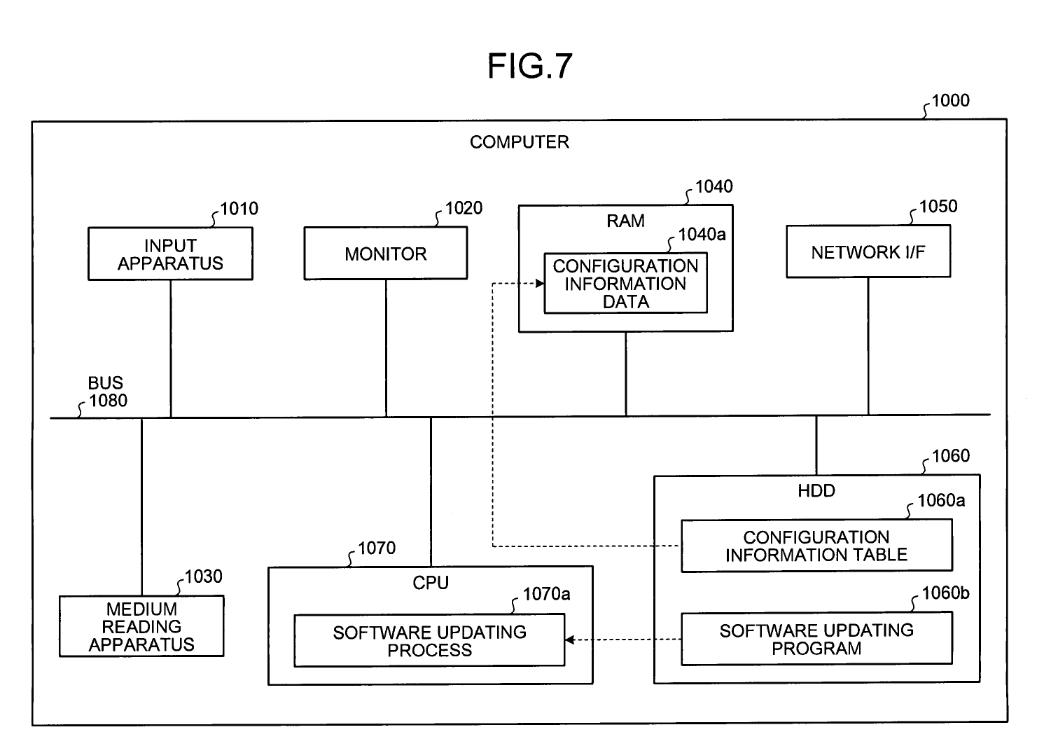

The various processings explained in the embodiment can be realized by executing a program prepared in advance in a computer. In the following, one example of a computer executing a software updating program will be explained with reference to FIG. 7.

FIG. 7 is a functional block diagram showing a computer executing a software updating program. A computer 1000 is constituted by connecting an input apparatus 1010 that receives input of data from a user, a monitor 1020, a medium reading apparatus 1030 that reads a program(s) from a recording medium storing various programs therein, a random access memory (RAM) 1040 that temporarily stores various information pieces, a network interface 1050 that conducts reception/transmission of data from/to another computer via a network, a hard disk drive (HDD) 1060, and a central processing unit (CPU) 1070 via a bus 1080.

The HDD 1060 stores therein a software updating program 1060b that is a program that develops a function similar to a function of the software updating apparatus 100. The HDD 1060 also stores therein a configuration information table 1060a corresponding to the configuration information DB 121 shown in FIG. 3.

Incidentally, the configuration information table 1060a and the software updating program 1060b may be stored properly in an integrated or distributed manner.

The CPU 1070 reads the software updating program 1060b from the HDD 1060 to execute the program, so that the program functions as a software updating process 1070a. The software updating process 1070a corresponds to the control unit 110 shown in FIG. 3.

The CPU 1070 reads various data pieces about a hardware configuration and a software configuration of an information processing apparatus(es) from the configuration information table 1060a in the HDD 1060 to store them in the RAM 1040 as configuration information data 1040a, and performs various data processings based upon the configuration information date 1040a stored in the RAM 1040.

Incidentally, it is not required to store the software updating program 1060b in the HDD 1060 necessarily. Such a constitution can be employed that the computer 1000 reads the software updating program 1060b stored in such a recording medium as a CD-ROM to execute the same. Such a constitution may be also employed that the software updating program 1060b is stored in another computer.(a server) or the like connected to the computer 1000 via a public line, Internet, LAN, WAN, or the like, and the computer 1000 reads the program from the another computer (the server) to execute the same.

As described above, in the embodiment, since steps of selecting information processing apparatuses having the same configuration as that of the test machine that has performed the operation validation for the correction file to transmitting a correction file to the information processing apparatuses to apply the file to them are automatically performed, even if a plurality of information processing apparatuses to be applied with the collection file are present, burden imposed on a system manager can be avoided from increasing.

In the embodiment, since constitution is made to distribute the test program together with the correction file, execute the test program after application of the correction file, and collect the execution results to notify the same to a system manager, burden imposed on the system manager requiring an operation validation work can be reduced.

According to the aspect of the present invention, burden imposed on system managers can be reduced.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A computer program product that implements on a computer a method of updating a software that has been installed in a plurality of information processing apparatuses that are connected to each other via a network, the computer program product causing the computer to execute:
distributing to the information processing apparatuses both a correction file that contains data required for updating the software and a test program that performs operation validation of the software after installation of the correction file;
instructing execution of the test program to the information processing apparatuses after the information processing apparatuses have received the correction file and the test program and have installed the correction file;
acquiring a result of execution of the test program from the information processing apparatuses that have executed the test program; and
notifying the result.

2. The computer program product according to claim 1, further causing the computer to execute selecting an information processing apparatus that has same configuration as that of a predetermined information processing apparatus as an object for software updating based, upon configuration information about information processing apparatuses stored in a storage unit.

3. The computer program product according to claim 2, wherein the selecting includes determining whether a configuration of the selected information processing apparatus is the same as that of the predetermined information processing apparatus based upon coincidence in predetermined items of items included in the configuration information.

4. An apparatus that updates a software that has been installed in a plurality of information processing apparatuses that are connected to each other via a network, comprising:
a distributing unit that distributes to the information processing apparatuses both a correction file that contains data required for updating the software and a test program that performs operation validation of the software after installation of the correction file;
an instructing unit that instructs execution of the test program to the information processing apparatuses after the information processing apparatuses have received the correction file and the test program and have installed the correction file;
a result acquiring unit that acquires a result of execution of the test program from the information processing apparatuses that have executed the test program; and
a notifying unit that notifies the result.

5. The apparatus according to claim 4, further comprising a selecting unit that selects an information processing apparatus that has same configuration as that of a predetermined information processing apparatus as an object for software updating based upon configuration information about information processing apparatuses stored in a storage unit.

6. The apparatus according to claim 5, wherein the selecting unit determines whether a configuration of the selected information processing apparatus is the same as that of the predetermined information processing apparatus based upon coincidence in predetermined items of items included in the configuration information.

7. A method of updating a software that has been installed in a plurality of information processing apparatuses that are connected to each other via a network, comprising:
distributing to the information processing apparatuses both a correction file that contains data required for updating the software and a test program that performs operation validation of the software after installation of the correction file;
instructing execution of the test program to the information processing apparatuses after the information processing apparatuses have received the correction file and the test program and have installed the correction file;
acquiring a result of execution of the test program from the information processing apparatuses that have executed the test program; and
notifying the result.

8. The method according to claim 7, further causing the computer to execute selecting an information processing apparatus that has same configuration as that of a predetermined information processing apparatus as an object for software updating based upon configuration information about information processing apparatuses stored in a storage unit.

9. The method according to claim 8, wherein the selecting includes determining whether a configuration of the selected information processing apparatus is the same as that of the predetermined information processing apparatus based upon coincidence in predetermined items of items included in the configuration information.
